(19) United States
(12) Patent Application Publication
(10) Pub. No.: US 2025/0274493 A1
(43) Pub. Date: Aug. 28, 2025

(54) COMMUNICATION METHOD AND APPARATUS

(71) Applicant: Huawei Technologies Co., Ltd., Shenzhen (CN)

(72) Inventors: Yurong Song, Beijing (CN); Fei Liu, Singapore (SG); Donghui Wang, Beijing (CN)

(21) Appl. No.: 19/204,036

(22) Filed: May 9, 2025

Related U.S. Application Data
(63) Continuation of application No. PCT/CN2022/131518, filed on Nov. 11, 2022.

(51) Int. Cl. H04L 9/40

(52) U.S. Cl. CPC H04L 63/205

(57) ABSTRACT

This application provides a communication method. The method includes: A first security module generates a security policy based on a trustworthiness requirement statement of a first node and/or a network global trustworthiness policy of the first node and a trustworthiness requirement statement of a second node and/or the network global trustworthiness policy of the second node, where the first security module is a security module serving the first node, and the second security module is a security module serving the second node; and the first security module sends the security policy to the second security module, where the security policy is used for secure communication between the first node and the second node.

### CROSS-REFERENCE TO RELATED APPLICATIONS

This application is a continuation of International Application No. PCT/CN2022/131518, filed on Nov. 11, 2022, the disclosure of which is hereby incorporated by reference in its entirety.

### TECHNICAL FIELD

This application relates to the communication field, and more specifically, to a communication method and a communication apparatus.

### BACKGROUND

A communication network security technology is an interdisciplinary technology of a communication network and security. The communication network security technology is implemented based on security policy negotiation between two communication parties. In a conventional technology, security policy negotiation is initiated by a network side, to generate a security policy based on capability lists of the two communication parties.

With development of communication technologies, because a security requirement of a user constantly changes, it is difficult for the existing security policy generated based on the capability lists during security policy negotiation to meet the security requirement of the user. For example, the security requirement of the user changes in different service scenarios, but the network side cannot autonomously detect the change of the security requirement of the user, and still uses the original security policy. For another example, when the security requirement of the user changes, the user cannot actively trigger a new security policy negotiation procedure, and still passively uses the original security policy, which poses a definite challenge to security.

Therefore, during security policy negotiation, how to generate a security policy that meets a security requirement of a user becomes a problem worthy of attention.

### SUMMARY

This application provides a communication method and a communication apparatus, so that security policy negotiation can be performed based on a security requirement of a user, to generate a security policy. This is applicable to security requirements in more service scenarios, and improves communication security.

According to a first aspect, a communication method is provided. The method may be performed by a first security module. The first security module may be a security function unit, module, or device, or may be a chip or a circuit in a security function unit, module, or device, or may be a logical module or software that can implement all or some security functions. This is not limited in this application.

The method includes: The first security module generates a security policy based on first information and second information, where the first information includes a trustworthiness requirement statement of a first node and/or a network global trustworthiness policy of the first node, the second information includes a trustworthiness requirement statement of a second node and/or a network global trustworthiness policy of the second node, the first security module is a security module serving the first node, and the second security module is a security module serving the second node; and the first security module sends the security policy to the second security module, where the security policy is used for secure communication between the first node and the second node.

According to the foregoing technical solution, an independent security function module (the first security module or the second security module) is deployed on a communication node (the first node or the second node), to enable a security policy negotiation procedure of the communication node based on a communication requirement in a communication system. The security function module on the communication node generates the security policy based on a security requirement and a security capability of the communication node in the security negotiation procedure. This is applicable to security requirements of the node in more service scenarios, and improves communication security.

With reference to the first aspect, in a possible implementation, the first security module receives the second information from the second security module.

In this solution, when the first security module stores the second information that can be directly used, the first security module may directly generate the security policy based on the first information and the second information, thereby reducing a communication delay. However, when the first security module does not have the second information that can be directly used, the second information may be obtained by using the second security module, thereby ensuring that a security requirement of the second node has time validity.

It should be understood that the first security module may directly obtain the second information from the second security module, or may obtain the second information through forwarding by the first node and the second node.

With reference to the first aspect, in a possible implementation, the first security module receives a first request message from the second security module, where the first request message is used to request the first security module to perform security negotiation, and the first request message includes the second information.

In this solution, the second security module triggers a security policy negotiation procedure, and includes the second information in the negotiation request message (the first request message), to reduce overheads and a delay.

With reference to the first aspect, in a possible implementation, the first security module sends a second request message to the second security module, where the second request message is used to request the second security module to perform security negotiation.

In this solution, the first security module triggers a security policy negotiation procedure, and the second security module sends the second information to the first security module, to generate the security policy. It can be learned that the solution is flexible, and a negotiation procedure can be triggered when any communication node has a policy negotiation requirement.

With reference to the first aspect, in a possible implementation, the first information further includes a trustworthiness configuration obtained from a management end, and the second information further includes a trustworthiness configuration obtained from the management end.

According to a second aspect, a communication method is provided. The method may be performed by a second security module. The second security module may be a security function unit, module, or device, or may be a chip or a circuit in a security function unit, module, or device, or may be a logical module or software that can implement all or some security functions. This is not limited in this application.

The method includes: The second security module determines second information, where the second information is used by a first security module to generate a security policy based on first information, the first information includes a trustworthiness requirement statement of a first node and/or a network global trustworthiness policy of the first node, the second information includes a trustworthiness requirement statement of a second node and/or a network global trustworthiness policy of the second node, the first security module is a security module serving the first node, and the second security module is a security module serving the second node; and the second security module receives the security policy from the first security module, where the security policy is used for secure communication between the first node and the second node.

According to the foregoing technical solution, an independent security function module is deployed on a communication node (the first node or the second node), to enable a security policy negotiation procedure of the communication node based on a communication requirement in a communication system. The security function module on the communication node generates the security policy based on a security requirement and a security capability of the communication node in the security negotiation procedure. This is applicable to security requirements of the node in more service scenarios, and improves communication security.

With reference to the second aspect, in a possible implementation, the second security module sends the second information to the first security module.

In this solution, when the first security module stores the second information that can be directly used, the first security module may directly generate the security policy based on the first information and the second information, thereby reducing a communication delay. However, when the first security module does not have the second information that can be directly used, the second information may be obtained by using the second security module, thereby ensuring that a security requirement of the second node has time validity.

With reference to the second aspect, in a possible implementation, the second security module sends a first request message to the first security module, where the first request message is used to request the first security module to perform security negotiation, and the first request message includes the second information.

In this solution, the second security module triggers a security policy negotiation procedure, and includes the second information in the negotiation request message (the first request message), to reduce overheads and a delay.

With reference to the second aspect, in a possible implementation, the second security module receives a second request message from the first security module, where the second request message is used to request the second security module to perform security negotiation.

In this solution, the first security module triggers a security policy negotiation procedure, and the second security module sends the second information to the first security module, to generate the security policy. It can be learned that the solution is flexible, and a negotiation procedure can be triggered when any communication node has a policy negotiation requirement.

With reference to the second aspect, in a possible implementation, the first information further includes a trustworthiness configuration obtained from a management end, and the second information further includes a trustworthiness configuration obtained from the management end.

According to a third aspect, a communication apparatus is provided. The apparatus may be a first security module. The first security module may be a security function unit, module, or device, or may be a chip or a circuit in a security function unit, module, or device, or may be a logical module or software that can implement all or some security functions. This is not limited in this application.

The apparatus includes: a processing unit, configured to generate a security policy based on first information and second information, where the first information includes a trustworthiness requirement statement of a first node and/or a network global trustworthiness policy of the first node, the second information includes a trustworthiness requirement statement of a second node and/or a network global trustworthiness policy of the second node, the first security module is a security module serving the first node, and a second security module is a security module serving the second node; and a transceiver unit, configured to send the security policy to the second security module, where the security policy is used for secure communication between the first node and the second node.

With reference to the third aspect, in a possible implementation, the transceiver unit is further configured to receive the second information from the second security module.

With reference to the third aspect, in a possible implementation, the transceiver unit is specifically configured to receive a first request message from the second security module, where the first request message is used to request the first security module to perform security negotiation, and the first request message includes the second information.

With reference to the third aspect, in a possible implementation, the transceiver unit is specifically configured to send a second request message to the second security module, where the second request message is used to request the second security module to perform security negotiation.

With reference to the third aspect, in a possible implementation, the first information further includes a trustworthiness configuration obtained from a management end, and the second information further includes a trustworthiness configuration obtained from the management end.

According to a fourth aspect, a communication apparatus is provided. The apparatus may be a second security module. The second security module may be a security function unit, module, or device, or may be a chip or a circuit in a security function unit, module, or device, or may be a logical module or software that can implement all or some security functions. This is not limited in this application.

The apparatus includes: a processing unit, configured to determine second information, where the second information is used by a first security module to generate a security policy based on first information, the first information includes a trustworthiness requirement statement of a first node and/or a network global trustworthiness policy of the first node, the second information includes a trustworthiness requirement statement of a second node and/or a network global trustworthiness policy of the second node, the first security module is a security module serving the first node, and the second security module is a security module serving the second node; and a transceiver unit, configured to receive the security policy from the first security module, where the security policy is used for secure communication between the first node and the second node.

With reference to the fourth aspect, in a possible implementation, the transceiver unit is further configured to send the second information to the first security module.

With reference to the fourth aspect, in a possible implementation, the transceiver unit is specifically configured to send a first request message to the first security module, where the first request message is used to request the first security module to perform security negotiation, and the first request message includes the second information.

With reference to the fourth aspect, in a possible implementation, the transceiver unit is specifically configured to receive a second request message from the first security module, where the second request message is used to request the second security module to perform security negotiation.

With reference to the fourth aspect, in a possible implementation, the first

information further includes a trustworthiness configuration obtained from a management end, and the second information further includes a trustworthiness configuration obtained from the management end.

With reference to the fourth aspect, in a possible implementation, the processing unit is further configured to store the security policy.

According to a fifth aspect, a communication apparatus is provided. The apparatus includes a processor. The processor is coupled to a memory, and may be configured to execute instructions in the memory, to implement the method according to either of the first aspect and the second aspect and any one of the possible implementations of the first aspect and the second aspect. Optionally, the apparatus further includes the memory. The memory and the processor may be separately deployed, or may be deployed in a centralized manner. Optionally, the apparatus further includes a communication interface, and the processor is coupled to the communication interface. In an implementation, the communication interface may be a transceiver or an input/output interface.

When the apparatus is a chip, the communication interface may be an input/output interface, an interface circuit, an output circuit, an input circuit, a pin, a related circuit, or the like on the chip or a chip system. The processor may alternatively be embodied as a processing circuit or a logic circuit.

Optionally, the transceiver may be a transceiver circuit. Optionally, the input/output interface may be an input/output circuit.

In a specific implementation process, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, but not limited to, a receiver, a signal output by the output circuit may be output to, but not limited to, a transmitter and transmitted by the transmitter, and the input circuit and the output circuit may be a same circuit, where the circuit is used as the input circuit and the output circuit at different moments. Specific implementations of the processor and the various circuits are not limited in embodiments of this application.

According to a sixth aspect, a communication apparatus is provided. The apparatus includes a logic circuit and an input/output interface. The logic circuit is configured to be coupled to the input/output interface, and transmit data through the input/output interface, to perform the method according to either of the first aspect and the second aspect and any one of the possible implementations of the first aspect and the second aspect.

According to a seventh aspect, a communication system is provided. The system includes the first module in any one of the possible implementations of the first aspect or the second aspect.

According to an eighth aspect, a computer-readable storage medium is provided. The computer-readable storage medium stores a computer program (which may also be referred to as code or instructions). When the computer program is run on a computer, the computer is enabled to perform the method according to either of the first aspect and the second aspect and any one of the possible implementations of the first aspect and the second aspect.

According to a ninth aspect, a computer program product is provided. The computer program product includes a computer program (which may also be referred to as code or instructions). When the computer program is run, a computer is enabled to perform the method according to either of the first aspect and the second aspect and any one of the possible implementations of the first aspect and the second aspect.

According to a tenth aspect, a circuit system is provided, and includes a memory and a processor. The memory is configured to store a computer program, and the processor is configured to invoke the computer program from the memory and run the computer program, so that a communication device on which the circuit system is installed performs the method according to any one of the possible implementations of the first aspect or the second aspect.

The circuit system may include an input circuit or interface configured to send information or data, and an output circuit or interface configured to receive information or data.

According to an eleventh aspect, a circuit system is provided, and is configured to perform the method according to any one of the possible implementations of the first aspect or the second aspect.

For beneficial effects brought by the third aspect to the eleventh aspect, refer to the descriptions of the beneficial effects in the first aspect and the second aspect. Details are not described herein again.

### BRIEF DESCRIPTION OF THE DRAWINGS

FIG. 1 is a diagram of a wireless communication system 100 applicable to an embodiment of this application;

FIG. 2 is a diagram of a network architecture 200 applicable to an embodiment of this application;

FIG. 3 is a diagram of a network architecture 300 applicable to an embodiment of this application;

FIG. 4 is an interaction diagram of a communication method applicable to a specific embodiment of this application;

FIG. 5A and FIG. 5B are a schematic flowchart of a communication method applicable to a specific embodiment of this application;

FIG. 6A and FIG. 6B are another schematic flowchart of a communication method applicable to a specific embodiment of this application;

FIG. 7(a) to FIG. 7(f) show procedures of triggering security policy negotiation procedures in different application scenarios applicable to a specific embodiment of this application;

FIG. 8(a) and FIG. 8(b) each shows a security negotiation procedure triggered by a change of a communication node applicable to a specific embodiment of this application;

FIG. 9 is a block diagram of a communication apparatus applicable to an embodiment of this application; and

FIG. 10 is a diagram of an architecture of a communication apparatus applicable to an embodiment of this application.

### DETAILED DESCRIPTION OF ILLUSTRATIVE EMBODIMENTS

The following describes technical solutions in this application with reference to accompanying drawings.

The technical solutions in embodiments of this application may be applied to various communication systems, for example, a global system for mobile communications (GSM) system, a code division multiple access (CDMA) system, a wideband code division multiple access (WCDMA) system, a general packet radio service (GPRS) system, a long term evolution (Long Term Evolution, LTE) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) mobile communication system, a new radio (NR) system, a wireless local area network (WLAN) system, and a wireless fidelity (Wi-Fi) system. The 5G mobile communication system may be non-standalone (NSA) or standalone ( ).

The technical solutions provided in this application may be further applied to a machine type communication (MTC) network, a machine-to-machine communication long term evolution technology (LTE-M) network, a device-to-device (D2D) network, a machine-to-machine (M2M) network, an internet of things (IoT) network, or another network. The IoT network may include, for example, an internet of vehicles. Communication manners in an internet of vehicles system are collectively referred to as vehicle to X (V2X, where X may represent anything). For example, the V2X may include vehicle to vehicle (V2V) communication, vehicle to infrastructure (V2I) communication, vehicle to pedestrian (V2P) communication, or vehicle to network (V2N) communication.

The technical solutions provided in this application may be further applied to a future communication system, for example, a 6th generation (6G) mobile communication system. This is not limited in this application.

The following clearly and completely describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application without creative efforts shall fall within the protection scope of this application.

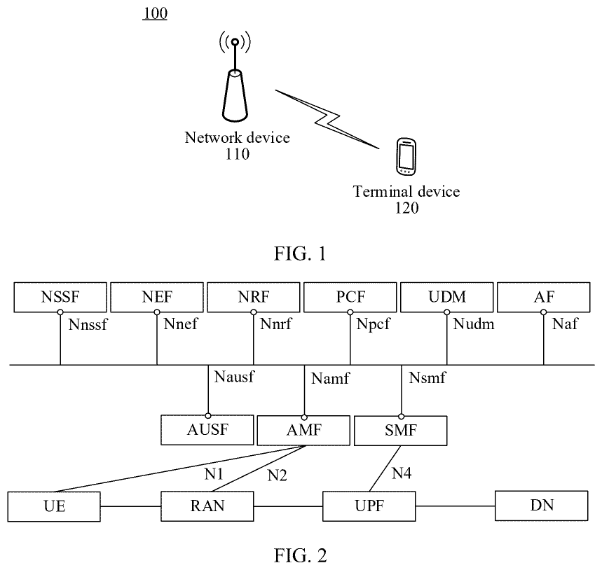

FIG. 1 is a diagram of a communication system 100 applicable to an embodiment of this application. As shown in FIG. 1, the communication system 100 may include at least one network device, for example, a network device 110 shown in FIG. 1. The communication system 100 may further include at least one terminal device, for example, a terminal device 120 shown in FIG. 1. The network device 110 and the terminal device 120 may communicate with each other through a radio link. A plurality of antennas may be configured for each communication device, for example, the network device 110 or the terminal device 120. For each communication device in the communication system, the plurality of configured antennas may include at least one transmit antenna configured to send a signal and at least one receive antenna configured to receive a signal. Therefore, the communication devices in the communication system, for example, the network device 110 and the terminal device 120, may communicate with each other by using a multi-antenna technology.

It should be understood that FIG. 1 is merely a simplified diagram used as an example for ease of understanding. The communication system may further include another network device or another terminal device that is not shown in FIG. 1.

It should be further understood that the communication system 100 shown in FIG. 1 is merely an example of an application scenario of embodiments of this application. This application is further applicable to communication between any two devices, for example, applicable to communication between terminal devices, or applicable to communication between network devices.

FIG. 2 is a diagram of a network architecture 200 applicable to a communication system in this application.

As shown in FIG. 2, the network architecture of the communication system includes but is not limited to the following network elements.
1. User equipment (UE): The user equipment in embodiments of this application may also be referred to as user equipment (UE), a mobile station (MS), a mobile terminal (MT), an access terminal, a subscriber unit, a subscriber station, a mobile station, a remote station, a remote terminal, a mobile device, a user terminal, a terminal, a wireless communication device, a user agent, a user apparatus, or the like.

The user equipment may be a device that provides voice/data connectivity for a user, for example, a handheld device or a vehicle-mounted device that has a wireless connection function. Currently, some terminals are, for example, a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device or a computing device that has a wireless communication function or another processing device connected to a wireless modem, a vehicle-mounted device, a wearable device, user equipment in a future 5G network, and user equipment in a future evolved public land mobile network (PLMN). This is not limited in embodiments of this application.

By way of example, and not limitation, in embodiments of this application, the user equipment may alternatively be a wearable device. The wearable device may also be referred to as a wearable intelligent device, and is a general term of wearable devices that are intelligently designed and developed for daily wear by using a wearable technology, for example, glasses, gloves, watches, clothes, and shoes. The wearable device is a portable device that is directly worn on a body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement complete or partial functions without depending on smartphones, such as smart watches or smart glasses, and devices that dedicated to only one type of application function and need to work with other devices such as smartphones, such as various smart bands or smart jewelry for monitoring physical signs.

In addition, in embodiments of this application, the user equipment may alternatively be user equipment in an internet of things (IoT) system. IoT is an important part in future development of information technologies. A main technical feature of the IoT is to connect things to a network by using a communication technology, to implement an intelligent network for human-machine interconnection and thing-thing interconnection.

In embodiments of this application, an IoT technology can implement massive connections, deep coverage, and terminal power saving by using, for example, a narrow band NB technology. For example, an NB may include one resource block (RB), to be specific, bandwidth of the NB is only 180 KB. To implement massive access, terminals need to be discrete in access. According to a communication method in embodiments of this application, a congestion problem that occurs when massive terminals access a network through the NB in the IoT technology can be effectively resolved.

In addition, an access device in embodiments of this application may be a device configured to communicate with the user equipment, and the access device may also be referred to as an access network device or a radio access network device. For example, the access device may be an evolved NodeB (eNB or eNodeB) in an LTE system, or may be a radio controller in a cloud radio access network (CRAN) scenario, or may be a relay station, an access point, a vehicle-mounted device, a wearable device, an access device in a future 5G network, or an access device in a future evolved PLMN network, or may be an access point (AP) in a WLAN, or may be a gNB in a new radio (NR) system. This is not limited in embodiments of this application.

In addition, in embodiments of this application, the user equipment may further communicate with user equipment in another communication system, for example, perform inter-device communication. For example, the user equipment may further perform time synchronization packet transmission (for example, sending and/or receiving) with user equipment in another communication system.
2. Access device (AN/RAN): The access device in embodiments of this application may be a device configured to communicate with the user equipment. The access device may also be referred to as an access network device or a radio access network device. For example, the access device may be an evolved NodeB (eNB or eNodeB) in an LTE system, or may be a radio controller in a cloud radio access network (CRAN) scenario, or may be a relay station, an access point, a vehicle-mounted device, a wearable device, an access device in a future 5G network, or an access device in a future evolved PLMN network, or may be an access point (AP) in a WLAN, or may be a gNB in an NR system. This is not limited in embodiments of this application.

In addition, in embodiments of this application, the access device is a device in a RAN, in other words, is a RAN node that connects the user equipment to a wireless network. For example, by way of example, and not limitation, the access device may be a gNB, a transmission reception point (TRP), an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (base band unit, BBU), or a wireless fidelity (Wi-Fi) access point (AP). In a network structure, a network device may include a central unit (CU) node or a distributed unit (DU) node, a RAN device including a CU node and a DU node, or a RAN device including a control plane CU node (CU-CP node), a user plane CU node (CU-UP node), and a DU node.

The access device serves a cell. The user equipment communicates with the access device on a transmission resource (for example, a frequency domain resource, or in other words, a frequency spectrum resource) used for the cell. The cell may be a cell corresponding to the access device (for example, a base station). The cell may belong to a macro base station, or a base station corresponding to a small cell. The small cell herein may include a metro cell, a micro cell, a pico cell, a femto cell, or the like. These small cells have features of small coverage and low transmit power, and are applicable to providing a high-rate data transmission service.

In addition, a plurality of cells may simultaneously work in a same frequency band on a carrier in the LTE system or the 5G system. In some special scenarios, it may also be considered that a concept of the carrier is equivalent to that of the cell. For example, in a carrier aggregation (CA) scenario, both a carrier index of a secondary component carrier and a cell identifier (Cell ID) of a secondary cell that works on the secondary component carrier are carried when the secondary component carrier is configured for a UE. In this case, it may be considered that the concept of the carrier is equivalent to that of the cell. For example, that the user equipment accesses the carrier is equivalent to that the terminal device accesses the cell.

The communication system in this application is further applicable to a vehicle to everything (V2X) technology. To be specific, the user equipment in this application may alternatively be a vehicle, for example, an intelligent vehicle or a self-driving vehicle.

“X” in V2X represents different communication targets, and V2X may include but is not limited to vehicle to vehicle (V2V), vehicle to infrastructure (V2I), vehicle to network (V2N), and vehicle to pedestrian (V2P).

In the V2X, the access device may configure a “zone” for the UE. The zone may also be referred to as a geographical zone. After the zone configuration, the world is divided into a plurality of zones, and the zones are defined by reference points, lengths, and widths. When determining a zone identifier (ID), the UE uses a zone length, a zone width, a quantity of zones in the length, a quantity of zones in the width, and a zone reference point to perform a remainder operation. The foregoing information may be configured by the access device.

A V2X service may be provided in two manners: a manner based on a proximity-based services communication (Proximity-based Services Communication 5, PC5) interface and a manner based on a Uu-based interface. The PC5 interface is defined based on a sidelink. Communication devices (for example, vehicles) may directly communicate with each other through such interface. The PC5 interface may be used out of coverage (OOC) and in coverage (IC), but only an authorized communication device can use the PC5 interface for transmission.
3. An access and mobility management function (AMF) network element is mainly configured for mobility management, access management, and the like, and may be configured to implement functions other than session management in functions of a mobility management entity (MME) in an LTE system, for example, functions such as lawful interception and access authorization/authentication. When providing a service for a session in the user equipment, the AMF network element provides a control plane storage resource for the session, to store a session identifier, an SMF network element identifier associated with the session identifier, and the like. In embodiments of this application, the access and mobility management function network element may be configured to implement a function of an access and mobility management network element.
4. A session management function (SMF) network element is mainly configured for session management, allocation and management of internet protocol (IP) addresses of user equipment, selection and management of a user plane function, a termination point of a policy control or charging function interface, downlink data notification, and the like. In embodiments of this application, the session management function network element may be configured to implement a function of a session management network element.
5. A policy control (PCF) network element is a unified policy framework for guiding network behavior, and provides policy rule information, a traffic-based charging control function, and the like for control plane function network elements (such as AMF and SMF network elements).
6. A unified data management (UDM) network element is mainly responsible for processing of subscription data of the UE, including storage and management of a user identifier, user subscription data, authentication data, and the like.
7. A user plane function (UPF) network element may be configured to perform packet routing and forwarding, quality of service (QOS) processing of user plane data, or the like. User data may be accessed to a data network (DN) through the network element, or user data may be received from the data network and transmitted to the user equipment through the access network device. A transmission resource and a scheduling function that are used by the UPF network element to serve the user equipment are managed and controlled by the SMF network element. In embodiments of this application, the user plane function network element may be configured to implement a function of a user plane network element.
8. A network exposure function (NEF) network element is configured to securely expose, to the outside, a service, a capability, and the like that are provided by a 3GPP network function, and mainly supports secure interaction between a 3GPP network and a third-party application.
9. An application function (AF) network element is configured to: perform application-affected data routing, access a network exposure function network element, interact with a policy framework for policy control, or the like, for example, affect a data routing decision and a policy control function, or provide some third-party services for a network side.
10. A network slice selection function (, NSSF) network element is mainly responsible for selecting a network slice, and determining, based on slice selection assistance information, subscription information, and the like of a UE, a network slice instance that the UE is allowed to access.
11. An authentication server function (AUSF) network element supports authentication of 3GPP and non-3GPP access.
12. A network repository function (NRF) network element supports registration and discovery of a network function.
13. A unified data repository function (UDR) network element stores and obtains subscription data used by the UDM and the PCF.

In the network architecture, an N2 interface is a reference point between a RAN and an AMF entity, and is configured to send a NAS (Non-Access Stratum) message and the like. An N3 interface is a reference point between the RAN and the UPF network element, and is configured to perform user plane data transmission and the like. An N4 interface is a reference point between the SMF network element and the UPF network element, and is configured to perform transmission of information such as tunnel identification information of an N3 connection, data buffering indication information, and a downlink data notification message.

It should be understood that the UE, the (R)AN, the UPF, and the DN in FIG. 2 are generally referred to as data plane network functions and entities. Data traffic of a user may be transmitted by using a PDU session set up between the UE and the DN, and the transmission passes through two network functional entities: the (R)AN and the UPF. Other parts are referred to as control plane network functions and entities, and are mainly responsible for functions such as authentication and authorization, registration management, session management, mobility management, and policy control, to implement reliable and stable transmission of user-layer traffic.

It should be understood that the foregoing network architecture applied to embodiments of this application is merely an example of a network architecture described from a perspective of a conventional point-to-point architecture and a service-based architecture, and a network architecture applicable to embodiments of this application is not limited thereto. Any network architecture that can implement functions of the foregoing network elements is applicable to embodiments of this application.

It should be understood that names of the interfaces between the network elements in FIG. 2 are merely examples, and the interfaces may have other names during specific implementation. This is not specifically limited in this application. In addition, names of messages (or signaling) transmitted between the foregoing network elements are also merely examples, and do not constitute any limitation on functions of the messages.

It should be noted that the foregoing “network element” may also be referred to as an entity, a device, an apparatus, a module, or the like. This is not particularly limited in this application. In addition, in this application, for ease of understanding and description, descriptions of the “network element” are omitted in some descriptions. For example, the SMF network element is referred to as an SMF for short. In this case, the “SMF” should be understood as an SMF network element or an SMF entity. Descriptions of a same case or similar cases are omitted below.

It may be understood that the foregoing entities or functions may be network elements in a hardware device, software functions running on dedicated hardware, or virtualized functions instantiated on a platform (for example, a cloud platform).

It should be understood that the foregoing network architecture applied to embodiments of this application is used as an example to describe the service-based architecture. A core network sets dedicated network elements for different types of communication services. In other words, a communication-related function may be provided in a form of a service. In embodiments of this application, communication-related functions are not limited to the function network elements listed in FIG. 2. This is not limited in embodiments of this application.

It should be understood that, in the conventional technology, security is used as a function and distributed in communication nodes. For example, the AUSF supports authentication on 3GPP access and non-3GPP access. An SEAF provides an authentication function in a serving network, and may support an initial authentication procedure based on a subscription concealed identifier (SUCI). The AMF supports encryption and integrity protection of NAS signaling. The NRF supports a bidirectional authentication function with another NF, and supports an authorization function for another NF. The NEF supports a bidirectional authentication function with the AF, and supports encryption, integrity protection, and replay protection of a message between the NEF and the NF according to a transport layer security (TLS) protocol. A base station supports encryption, integrity protection, and replay protection of a message between the base station and the UE according to the PDCP protocol. A bidirectional authentication function, encryption, integrity protection, and replay protection are supported between a CU and a DU. The UE supports a bidirectional authentication function with the core network, supports encryption, integrity protection, and replay protection of NAS signaling between the UE and the core network, supports encryption, integrity protection, and replay protection of a radio resource control (RRC) message between the UE and the base station according to a packet data convergence protocol (PDCP), supports a privacy protection function of converting a subscription permanent identifier (SUPI) into a 5G globally unique temporary UE identifier (5G-GUTI), supports a security function visible to upper-layer applications, and supports a user-configurable security function, and the like.

It should be noted that security policy negotiation in an existing 5G network is mainly triggered by the network and is performed based on a security capability of a user. For example, security policy negotiation between the UE and the CN is mainly performed in a Security Mode Command phase of the NAS protocol. In an initial registration phase, the UE sends UE security capabilities IE to the AMF, and the AMF sends a SECURITY MODE COMMAND message carrying Selected EPS NAS security algorithms IE, to state encryption and integrity protection algorithms provided by the network for the UE. The UE sets the encryption and integrity protection algorithms. A security algorithm obtained through the security policy negotiation is determined by the network based on a security capability, and it is difficult to meet a security requirement of the user. For example, when a service scenario of the user changes, the network side cannot perceive a change of the security requirement of the user, and cannot provide a new security policy to meet a new security requirement. Apparently, security policy negotiation in existing security function deployment cannot meet a communication requirement, resulting in a communication security problem.

Secure transmission is a basic guarantee of communication. In embodiments of this application, an independent security function can be deployed, so that a security policy negotiation procedure of a communication node based on a communication requirement is enabled in a communication system. This is applicable to security requirements in more service scenarios, and improves communication security.

An embodiment of this application provides a security function module. The security function module is not limited to a form of hardware or software. In the following specific embodiments, a first module and a second module may be two different types of security function modules. A first security module and a second security module are two security function modules serving different communication nodes, and are represented by a security module #1 and a security module #2 respectively in the specific embodiments.

Based on different capability properties, the security function modules are specifically represented as the first module and the second module. The first module is configured to invoke a security algorithm, obtain a security parameter, or send a request for a security service to another security function module. The second module is configured to manage the security service or the first module.

For example, that the second module manages the security service may be managing, adding, or deleting a blockchain node, assigning a new capability (data on-chain, download, participation in a publicity mechanism, a smart contract, or the like) to the blockchain node in a blockchain service, or the like.

For example, the second module has a capability of analyzing network behavior data to formulate a security policy. After behavior information is collected, an AI capability of a 6G network can be used to analyze the behavior information and output policies. Alternatively, a third-party professional service capability can be integrated to anonymize the behavior data and then send the data to a third party for analysis and policy output. Alternatively, a third-party service module (for example, Defense solution) can be embedded into the second module and internalized as a part of the second module.

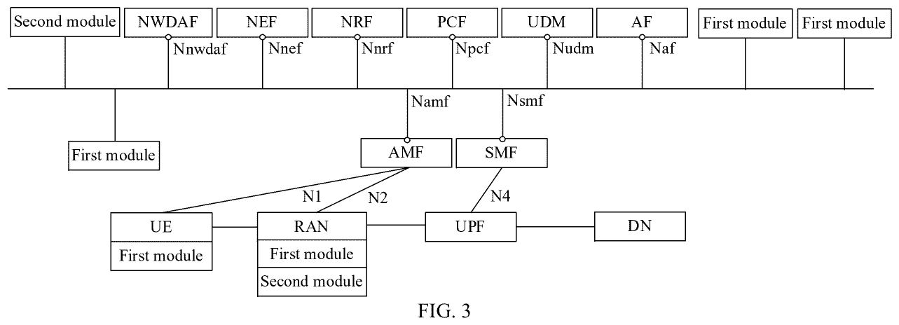

FIG. 3 is a diagram of a network architecture 300 applicable to this application.

An existing network architecture is used as an example, and a security function module may be deployed in an existing communication node. For example, the security function module may be deployed on a terminal side. As shown in FIG. 3, a first module may be integrated with a function of the UE, in other words, the first module may be deployed inside the UE. For example, the first module may be deployed on an ME, and communicates with a UICC through an interface, or may be combined with the UICC. The first module may be deployed separately from the UE, in other words, the first module may be deployed outside the UE as a functional entity. A security function may be deployed outside an access network device in a form of a functional entity, or may be deployed inside the access network device in a form of a logical function. For example, when the access network device may include a CU node and a DU node, the first module or the second module may be deployed only on the CU, or may be deployed on both the CU and the DU. The first module or the second module may be deployed on a core network device, or may be deployed outside the core network device in a form of a functional entity. For example, the first module in FIG. 3 is independently deployed on a bus in a form of a network function of a core network.

It should be noted that, based on requirements of different communication nodes, security function modules deployed on different nodes may implement different security functions. The following uses the first security module as an example for description. The first security module may serve any communication node or a third-party request node, and an example in which the any communication node or the third-party request node is a requester is used for description.

It should be understood that the foregoing deployment form is merely an example for description. No matter on a network side, a terminal side, or an application side, the security function module can serve as a unified external interface, which is a basis of multi-party negotiation and trustworthiness communication.

Specific embodiments are used below to describe in detail the technical solutions of this application. The following several specific embodiments may be combined with each other, and a same or similar concept or process may not be described repeatedly in some embodiments.

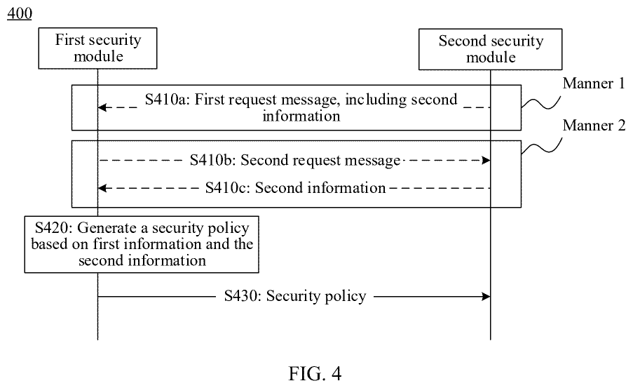

FIG. 4 is a diagram of a communication method 400 applicable to this application. The method 400 shown in FIG. 4 is applicable to the system or the architectures shown in FIG. 1 to FIG. 3. The method 400 includes the following steps.

S420: A first security module generates a security policy based on first information and second information.

In this application, the first security module performs security policy negotiation based on the first information and the second information, to generate the security policy.

The first information includes a trustworthiness requirement statement and/or a network global trustworthiness policy of a first node, and the second information includes a trustworthiness requirement statement and/or a network global trustworthiness policy of a second node.

It should be understood that a trustworthiness requirement statement of a communication node includes a requirement statement of the communication node for a trustworthiness capability.

It should be understood that a network global trustworthiness policy obtained by the communication node refers to a network global trustworthiness policy generated by another trustworthiness function or security module based on AI-based network-wide situational awareness. For example, communication between all nodes needs to support post-quantum encryption, trustworthiness certification needs to be performed on all nodes before communication, or all UEs need to support a blockchain light node capability.

In this application, two different types of security function modules are provided. The first security module and a second security module are of a first module type, and another trustworthiness function module or security module is of a second module type. In other words, the communication node obtains the network global trustworthiness policy from the security module of the second module type.

Optionally, the first information may further include a trustworthiness configuration obtained from a management end. The trustworthiness configuration may be understood as configuration performed by an operator on a trustworthiness function, for example, a time segment-based or coverage configuration, an event-triggered configuration, a user-customized enabling configuration, or a configuration for disabling some trustworthiness capabilities. This is not limited in embodiments of this application.

In this application, the first security module is a security module serving the first node. For example, if the first node is a UE, the first security module is a security module deployed in the UE. The second security module is a security module serving the second node. For example, if the second node is an access network device, the second security module is a security module deployed in the access network device. The second security module and the first security module are security function modules deployed in different communication nodes in a communication system.

It should be understood that the first node or the second node may be any communication node or application in the communication system, for example, may be a terminal device, an access network device, a core network element, or a third-party application. This is not limited in embodiments of this application.

In a possible implementation, the first security module inputs the first information and the second information into an AI model, to intelligently generate the security policy.

In another possible implementation, the first security module integrates the first information and the second information according to an expert library and/or a rule preset by an operator, to generate the security policy.

In a possible implementation, the first information and the second information may be stored by the first security module. For example, the first information and the second information are subject to a validity period, and within the validity period, the first security module may directly use the stored first information and second information. If the validity period expires, the first security module may obtain updated first information, and obtain updated second information from the second security module.

In another possible implementation, the first information and the second information are respectively obtained by the first security module and the second security module.

Specifically, the first security module obtains the trustworthiness requirement statement from the first node and/or obtains the network global trustworthiness policy from a second module to which the first security module belongs, and may further obtain a trustworthiness configuration from the management end.

Specifically, the second security module obtains the trustworthiness requirement statement from the second node and/or obtains the network global trustworthiness policy from a second module to which the second security module belongs, and may further obtain a trustworthiness configuration from the management end.

The second module to which the first security module belongs may be understood as that the first security module is of the first module type, and the second module may manage the first security module. For example, for a first module and a second module that are deployed on a RAN side shown in FIG. 3, when the first module herein is the first security module, the first security module may obtain the network global trustworthiness policy from the second module. The second module to which the second security module belongs is similar, and details are not described herein.

In this application, before S420, a security policy negotiation procedure may be further triggered.

In an implementation, the second security module may trigger the security policy negotiation procedure.

S410a: The second security module sends a first request message to the first security module, where the first request message includes the second information.

The first request message is used to request security negotiation.

It should be understood that, that the second security module triggers the security policy negotiation procedure may be understood as that the second node sends a security policy request message including an ID of the first node to the second security module. If the second security module does not store a security policy corresponding to the ID of the first node, or a stored security policy corresponding to the ID of the first node expires, the second security module sends the first request message to the first security module of the first node based on the ID of the first node, to request to perform security policy negotiation to generate the security policy.

In another implementation, the first security module triggers the security policy negotiation procedure.

S410b: The first security module sends a second request message to the second security module, where the second request message is used to request security negotiation.

S410c: The second security module sends the second information to the first security module.

It should be understood that, that the first security module triggers the security policy negotiation procedure may be understood as that the first node sends a security policy request message including an ID of the second node to the first security module. If the first security module does not store a security policy corresponding to the ID of the second node, or a stored security policy corresponding to the ID of the second node expires, the first security module sends the second request message to the second security module of the second node based on the ID of the second node, to request to perform security policy negotiation to generate the security policy.

S430: The first security module sends the security policy to the second security module.

In a possible implementation, when the second security module sends the first request message to the first security module, the first security module sends a first feedback message to the second security module, where the first feedback message includes the security policy.

In a possible implementation, when the first security module sends the second request message to the second security module, the first security module sends first notification information to the second security module, where the first notification information includes the security policy.

Correspondingly, the second security module stores the security policy for communication between the first node and the second node. The second security module sends a feedback message to the second node, to indicate that the security policy negotiation succeeds or fails.

The security policy specifies a security algorithm and a security parameter that are to be specifically invoked, for example, an authentication and key agreement (AKA) used for authentication between the first node and the second node, a trusted platform module (TPM) used for trustworthiness certification, and an advanced encryption standard (AES) algorithm used for encryption and decryption. After being generated, the security policy corresponds to an identifier and is stored in the first security module and the second security module. For example, the first security module stores an identifier of the second node and the security policy between the first node and the second node, and the second security module stores an identifier of the first node and the security policy between the first node and the second node.

After receiving a trustworthiness service request message, the first security module locates, by using the identifier of the second node, the security policy previously obtained through negotiation with the second security module, and determines a specific security algorithm to be invoked and a security parameter to be used.

According to this technical solution, an independent security function is deployed, so that a security policy negotiation procedure of a communication node based on a communication requirement is enabled in the communication system. This is applicable to security requirements in more service scenarios, and improves communication security.

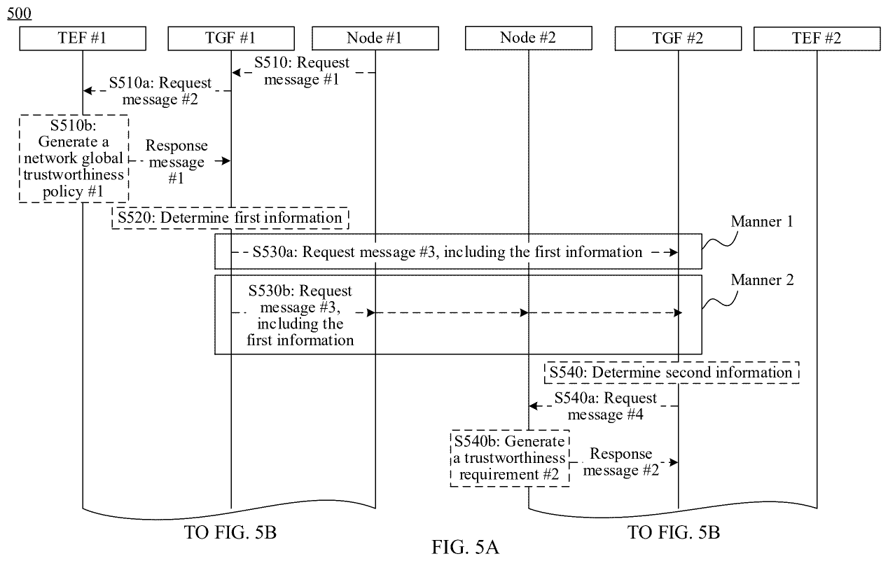

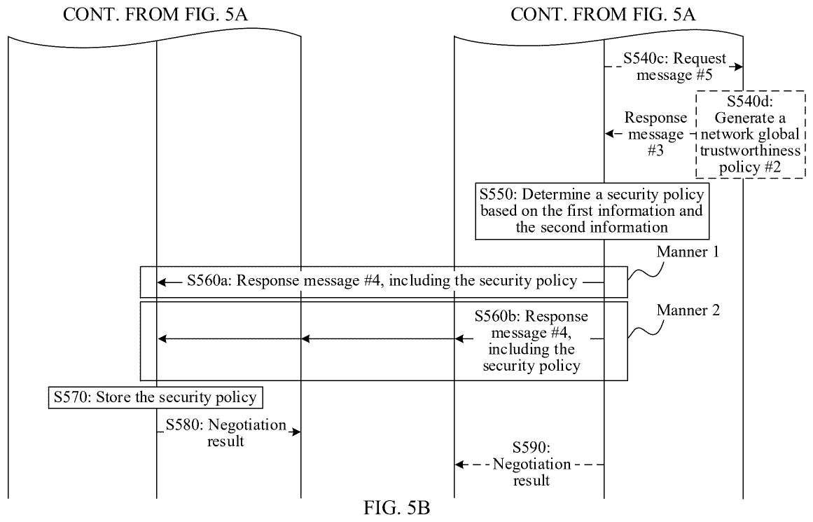

FIG. 5A and FIG. 5B are a flowchart of a communication method applicable to this application. The communication method shown in FIG. 5A and FIG. 5B may be a specific implementation of FIG. 4. Specifically, the method 500 includes the following steps.

In an embodiment, a security negotiation procedure between a node #1 and a node #2 is used as an example for description. A TGF #1 is used as a security function module of the node #1, a TGF #2 is used as a security function module of the node #2, and the TGF #1 (an example of a first security module) and the TGF #2 (an example of a second security module) are of a first module type. A TEF #1 is a security function module responsible for managing the TGF #1, a TEF #2 is a security function module responsible for managing the TGF #2, and the TEF #1 and the TEF #2 are of a second module type.

The node #1 (an example of a first node) and the node #2 (an example of a second node) may be any communication node or application in a communication system, for example, may be a terminal device, an access network device, a core network element, or a third-party application. This is not limited in embodiments of this application.

The following step S510 to step S590 are the security negotiation procedure between the node #1 and the node #2.

S510: The node #1 sends a request message #1 to the TGF #1.

The request message #1 is used to request the TGF #1 for a security policy between the node #1 and the node #2.

The request message #1 includes an ID of the node #2.

The request message #1 may be a security policy request message.

S510a: The TGF #1 sends a request message #2 to the TEF #1.

The request message #2 is used to request the TEF #1 to generate a network global trustworthiness policy #1.

S510b: The TEF #1 generates the network global trustworthiness policy #1 and sends a response message #1 to the TGF #1.

The response message #1 includes the network global trustworthiness policy #1.

It should be understood that when the TGF #1 prestores the network global trustworthiness policy #1, steps S510a and S510b may not be performed.

S520: The TGF #1 determines first information.

The first information includes at least one of a security requirement statement of the node #1 and the network global trustworthiness policy #1.

The first information may further include a trustworthiness configuration obtained by the TGF #1 from a management end.

It should be understood that the TGF #1 may prestore the first information. Therefore, the foregoing steps S510 to S520 may all be optional steps.

It should be understood that the TGF #1 may store the security policy between the node #1 and the node #2, and therefore may directly send the stored security policy to the node #2. When the stored security policy expires or no security policy is stored, the following steps are performed.

The TGF #1 requests, in two manners, the TGF #2 to perform security policy negotiation. A manner 1 is the following step S530a, and a manner 2 is the following step S530b.

S530a: The TGF #1 sends a request message #3 to the TGF #2, where the request message #3 includes the first information.

In other words, when the TGF #1 and the TGF #2 support direct communication, the request message #3 does not need to be forwarded by the node #1, the node #2, and another node.

S530b: The TGF #1 sends a request message #3 to the TGF #2 through the node #1 and the node #2, where the request message #3 includes the first information.

In other words, the TGF #1 and the TGF #2 do not support direct communication, and the request message #3 needs to be forwarded by the node #1, the node #2, and another node.

S540: The TGF #2 determines second information.

The second information includes at least one of a security requirement statement of the node #2 and a network global trustworthiness policy #2.

The second information may further include a trustworthiness configuration obtained by the TGF #2 from the management end.

S540a: The TGF #2 sends a request message #4 to the node #2.

The request message #4 is used to request the node #2 for a trustworthiness requirement of the node #2.

S540b: The node #2 generates a trustworthiness requirement #2 and sends a response message #2 to the TGF #2.

The response message #2 includes the trustworthiness requirement of the node #2.

S540c: The TGF #2 sends a request message #5 to the TEF #2.

The request message #5 is used to request the TEF #2 to generate the network global trustworthiness policy #2.

S540d: The TEF #2 generates the network global trustworthiness policy #2 and sends a response message #3 to the TGF #2.

The response message #3 includes the network global trustworthiness policy #2.

It should be understood that when the TGF #2 prestores the network global trustworthiness policy #2 and the trustworthiness requirement #2, steps S540a to S540d may not be performed.

It should be understood that the TGF #2 may prestore the second information. Therefore, the foregoing steps S510 to S540d may all be optional steps.

S550: The TGF #2 generates the security policy based on the first information and the second information.

In a possible implementation, the TGF #2 inputs the first information and the second information into an AI model, to intelligently generate the security policy.

In another possible implementation, the TGF #2 integrates the first information and the second information according to an expert library and/or a rule preset by an operator, to generate the security policy.

It should be understood that the TGF #2 stores the security policy after generating the security policy.

Corresponding to the foregoing two manners in which the TGF #1 requests the TGF #2 to perform security policy negotiation, there are also two response manners. A manner 1 is the following step S560a, and a manner 2 is the following step S560b.

S560a: The TGF #2 sends a response message #4 to the TGF #1, where the response message #4 includes the security policy.

S560b: The TGF #2 sends a response message #4 to the TGF #1 through the node #2and the node #1, where the response message #4 includes the security policy.

S570: The TGF #1 stores the security policy.

S580: The TGF #1 sends a negotiation result to the node #1.

The negotiation result includes an indication that the TGF #1 succeeds in obtaining the security policy or fails to obtain the security policy.

S590: The TGF #2 sends a negotiation result to the node #2.

The negotiation result includes an indication that the TGF #2 succeeds in obtaining the security policy or fails to obtain the security policy.

According to this technical solution, the TGF #1 requests the TGF #2 to perform security policy negotiation, and sends an identifier and security requirement related information of the node #1 to the TGF #2, and the TGF #2 generates a security policy based on the security requirement related information of the node #1 and security requirement related information of the node #2, so that a security policy negotiation procedure of a communication node based on a communication requirement is enabled in the communication system. This is applicable to security requirements in more service scenarios, and improves communication security.

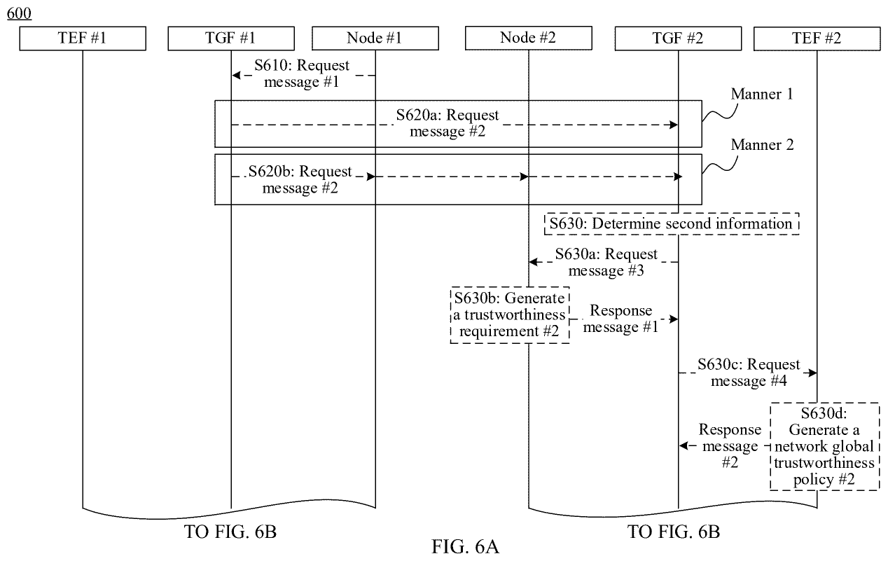

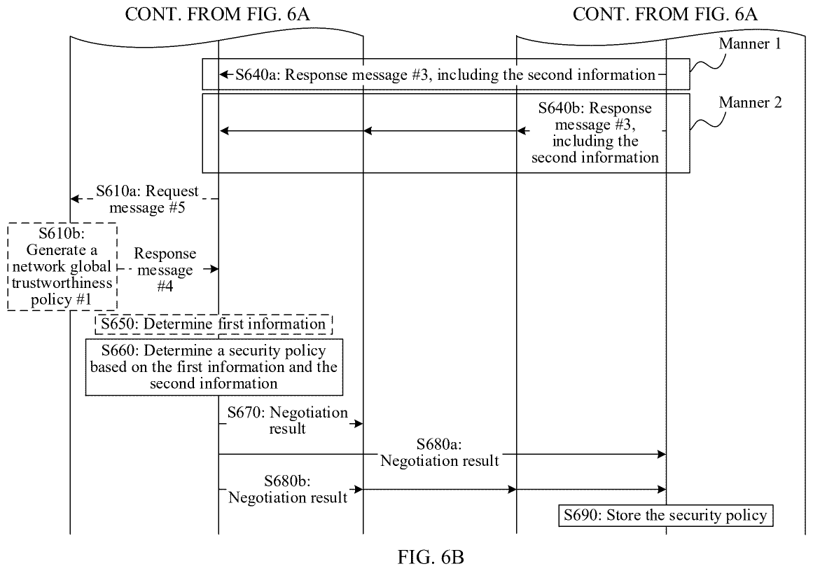

FIG. 6A and FIG. 6B are a flowchart of a communication method applicable to this application. The communication method shown in FIG. 6A and FIG. 6B may be a specific implementation of FIG. 4. Specifically, the method 600 includes the following steps.

In this embodiment, a security negotiation procedure between a node #1 and a node #2 is used as an example for description.

A TGF #1 is used as a security function module of the node #1, a TGF #2 is used as a security function module of the node #2, and the TGF #1 (an example of a first security module) and the TGF #2 (an example of a second security module) are of a first module type. A TEF #1 is a security function module responsible for managing the TGF #1, a TEF #2 is a security function module responsible for managing the TGF #2, and the TEF #1 and the TEF #2 are of a second module type.

The node #1 (an example of a first node) and the node #2 (an example of a second node) may be any communication node or application in a communication system, for example, may be a terminal device, an access network device, a core network element, or a third-party application. This is not limited in embodiments of this application.

The following step S610 to step S690 are the security negotiation procedure between the node #1 and the node #2.

S610: The node #1 sends a request message #1 to the TGF #1.

The request message #1 is used to request the TGF #1 for a security policy between the node #1 and the node #2.

The request message #1 includes an ID of the node #2.

The request message #1 may be a security policy request message.

It should be understood that the TGF #1 may store the security policy between the node #1 and the node #2, and therefore may directly send the stored security policy to the node #2. When the stored security policy expires or no security policy is stored, the following steps are performed.

The TGF #1 requests, in two manners, the TGF #2 to perform security policy negotiation. A manner 1 is the following step S620a, and a manner 2 is the following step S620b.

S620a: The TGF #1 sends a request message #2 to the TGF #2, where the request message #2 is used to request the node #2 for second information.

In other words, when the TGF #1 and the TGF #2 support direct communication, the request message #2 does not need to be forwarded by the node #1, the node #2, and another node.

The request message #2 may be a security policy negotiation request message.

S620b: The TGF #1 sends a request message #2 to the TGF #2 through the node #1 and the node #2, where the request message #2 is used to request the node #2 for second information.

In other words, the TGF #1 and the TGF #2 do not support direct communication, and the request message #2 needs to be forwarded by the node #1, the node #2, and another node.

S630: The TGF #2 determines the second information.

The second information includes at least one of a security requirement statement of the node #2 and a network global trustworthiness policy #2.

The second information may further include a trustworthiness configuration obtained by the TGF #2 from a management end.

S630a: The TGF #2 sends a request message #3 to the node #2.

The request message #3 is used to request the node #2 for a trustworthiness requirement of the node #2.

S630b: The node #2 generates a trustworthiness requirement #2 and sends a response message #1 to the TGF #2.

The response message #1 includes the trustworthiness requirement of the node #2.

S630c: The TGF #2 sends a request message #4 to the TEF #2.

The request message #4 is used to request the TEF #2 to generate the network global trustworthiness policy #2.

S630d: The TEF #2 generates the network global trustworthiness policy #2 and sends a response message #2 to the TGF #2.

The response message #2 includes the network global trustworthiness policy #2.

It should be understood that when the TGF #2 prestores the network global trustworthiness policy #2 and the trustworthiness requirement #2, steps S630a to S630d may not be performed.

It should be understood that the TGF #2 may prestore the second information. Therefore, the foregoing steps S610 to S630d may all be optional steps.

Corresponding to the foregoing two manners in which the TGF #1 requests the TGF #2 to perform security policy negotiation, there are also two response manners. A manner 1 is the following step S640a, and a manner 2 is the following step S640b.

S640a: The TGF #2 sends a response message #3 to the TGF #1, where the response message #3 includes the second information.

S640b: The TGF #2 sends a response message #3 to the TGF #1 through the node #2 and the node #1, where the response message #3 includes the second information.

When the TGF #1 has no available network global trustworthiness policy #1, the network global trustworthiness policy #1 needs to be obtained by using the following steps S610a and S610b.

S610a: The TGF #1 sends a request message #5 to the TEF #1.

The request message #5 is used to request the TEF #1 to generate the network global trustworthiness policy #1.

S610b: The TEF #1 generates the network global trustworthiness policy #1 and sends a response message #4 to the TGF #1.

The response message #4 includes the network global trustworthiness policy #1.

It should be understood that when the TGF #1 prestores the network global trustworthiness policy #1, steps S610a and S610b may not be performed.

S650: The TGF #1 determines first information.

The first information includes at least one of a security requirement statement of the node #1 and the network global trustworthiness policy #1.

The first information may further include a trustworthiness configuration obtained by the TGF #1 from the management end.

It should be understood that the TGF #1 may prestore the first information. Therefore, step S650 may be an optional step.

S660: The TGF #1 generates the security policy based on the first information and the second information.

In a possible implementation, the TGF #1 inputs the first information and the second information into an AI model, to intelligently generate the security policy.

In another possible implementation, the TGF #1 integrates the first information and the second information according to an expert library and/or a rule preset by an operator, to generate the security policy.

It should be understood that the TGF #1 stores the security policy after generating the security policy.

S670: The TGF #1 sends a negotiation result to the node #1, where the negotiation result includes an indication that the TGF #1 succeeds in obtaining the security policy or fails to obtain the security policy.

Corresponding to the foregoing two manners in which the TGF #1 requests the TGF #2 to perform security policy negotiation, there are also two manners of notifying a negotiation result: step S680a and step S680b.

S680a: The TGF #1 directly sends the negotiation result to the TGF #2.

The negotiation result includes the security policy.

S680b: The TGF #1 sends the negotiation result to the TGF #2 through the node #1 and the node #2.

The negotiation result includes the security policy.

S690: The TGF #2 stores the security policy.

According to this technical solution, the TGF #1 requests the TGF #2 to perform security policy negotiation, and sends an identifier of the node #1 to the TGF #2, the TGF #2 sends an identifier and security requirement related information of the node #2 to the TGF #1, and the TGF #1 generates the security policy based on security requirement related information of the node #1 and the security requirement related information of the node #2, so that a security policy negotiation procedure of a communication node based on a communication requirement is enabled in the communication system. This is applicable to security requirements in more service scenarios, and improves communication security.

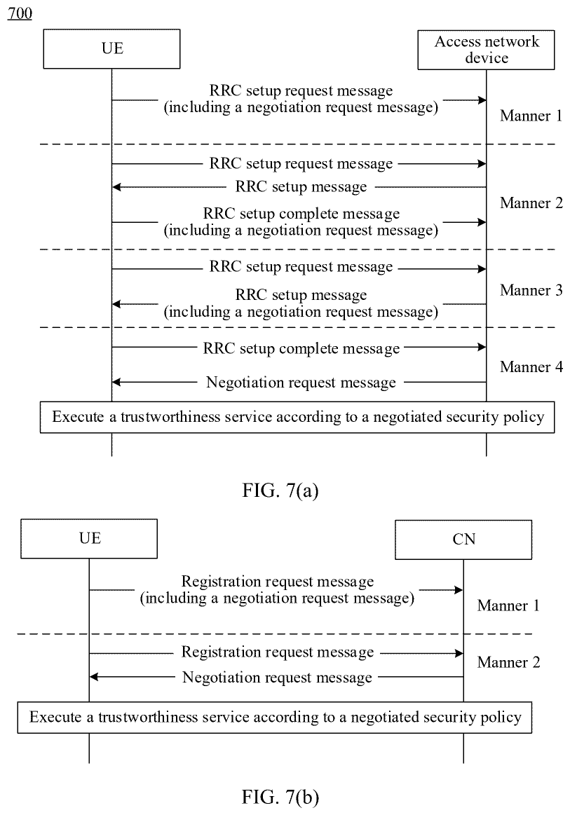

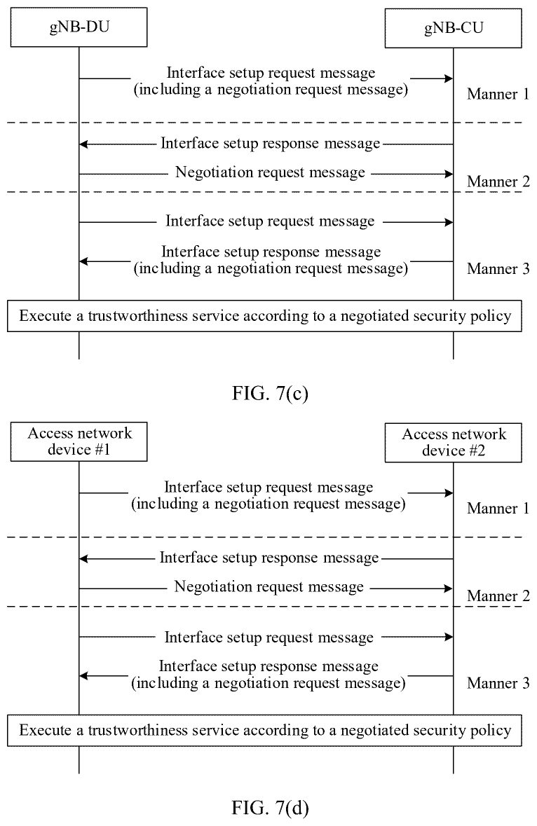

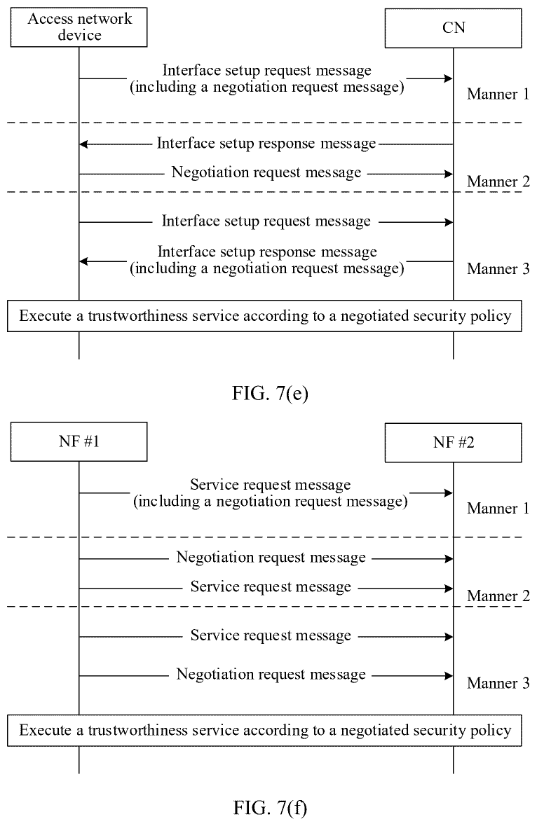

In this application, a security policy negotiation procedure between two nodes is applicable to a plurality of application scenarios. FIG. 7(a) to FIG. 7(f) show occasions of triggering security policy negotiation procedures in different application scenarios.

It should be understood that, in embodiments of this application, when a node triggers a security policy negotiation request, a security function module serving the node performs triggering and negotiation.

As shown in FIG. 7(a), a UE and an access network device may execute a security policy negotiation procedure in a UE access procedure. There are four manners of triggering security policy negotiation in the access procedure.

Manner 1: The UE sends an RRC setup request message to the access network device, where the RRC setup request message carries a negotiation request message. In other words, the UE actively triggers the security policy negotiation procedure when requesting to set up a connection.

Manner 2: The UE sends an RRC setup request message to the access network device, the access network device sends an RRC setup message to the UE, and the UE sends an RRC setup complete message carrying a negotiation request message to the access network device. In other words, the UE actively triggers the security policy negotiation procedure when a complete connection is set up.

Manner 3: The UE sends an RRC setup request message to the access network device, the access network device sends an RRC setup message carrying a negotiation request message to the UE. In other words, the access network device actively triggers the security policy negotiation procedure when setting up a connection.

Manner 4: The UE sends an RRC setup complete message to the access network device, and the access network device sends a negotiation request message to the UE. In other words, the access network device actively triggers the security policy negotiation procedure when a complete connection is set up.

After the negotiation procedure is triggered, for the specific negotiation procedure, refer to the method shown in FIG. 5A and FIG. 5B or FIG. 6A and FIG. 6B, to obtain a security policy and execute a specific trustworthiness service according to the negotiated security policy.

The foregoing four policy negotiation triggering scenarios are merely examples for description, and are not all triggering scenarios. For example, the UE sends the negotiation request message after sending the RRC setup request message. This is not limited in embodiments of this application.

As shown in FIG. 7(b), a UE and a core network may execute a security policy negotiation procedure in an authentication process. There are two manners of triggering security policy negotiation in the authentication process.

Manner 1: The UE sends a registration request message carrying a negotiation request message to the core network.

Manner 2: The UE sends a registration request message to the core network, and the core network sends a negotiation request message to the UE after receiving the registration request message.

It should be understood that, after storing a security policy, a security function module of the UE or the core network may periodically trigger a negotiation request. For example, a timer may be set for the security function module to periodically trigger the negotiation request and update the security policy.

After the negotiation procedure is triggered, for the specific negotiation procedure, refer to the method shown in FIG. 5A and FIG. 5B or FIG. 6A and FIG. 6B, to obtain the security policy and execute a specific trustworthiness service according to the negotiated security policy.

The foregoing two policy negotiation triggering scenarios are merely examples for description, and are not all triggering scenarios. This is not limited in embodiments of this application.

As shown in FIG. 7(c), when an access network device is divided into a CU and a DU, the CU and the DU may execute a security policy negotiation procedure in an interface setup process. There are three manners of triggering security policy negotiation in an interface setup process.

Manner 1: The DU sends an interface setup request message carrying a negotiation request message to the CU.

Manner 2: After the CU sends an interface setup response message to the DU, the DU sends a negotiation request message to the CU.

Manner 3: The DU sends an interface setup request message to the CU, and the CU sends an interface setup response message carrying a negotiation request message to the DU.

For example, the foregoing interface may be an F1 interface.

After the negotiation procedure is triggered, for the specific negotiation procedure, refer to the method shown in FIG. 5A and FIG. 5B or FIG. 6A and FIG. 6B, to obtain a security policy and execute a specific trustworthiness service according to the negotiated security policy.

The foregoing three policy negotiation triggering scenarios are merely examples for description, and are not all triggering scenarios. This is not limited in embodiments of this application.

As shown in FIG. 7(d), different access network devices may execute a security policy negotiation procedure in an interface setup process. There are three manners of triggering security policy negotiation in the interface setup process.

Manner 1: An access network device #1 sends an interface setup request message carrying a negotiation request message to an access network device #2.

Manner 2: After an access network device #2 sends an interface setup response message to an access network device #1, the access network device #1 sends a negotiation request message to the access network device #2.

Manner 3: An access network device #1 sends an interface setup request message to an access network device #2, and the access network device #2 sends an interface setup response message carrying a negotiation request message to the access network device #1.

For example, the foregoing interface may be an Xn interface.

After the negotiation procedure is triggered, for the specific negotiation procedure, refer to the method shown in FIG. 5A and FIG. 5B or FIG. 6A and FIG. 6B, to obtain a security policy and execute a specific trustworthiness service according to the negotiated security policy.

The foregoing three policy negotiation triggering scenarios are merely examples for description, and are not all triggering scenarios. This is not limited in embodiments of this application.

As shown in FIG. 7(e), an access network device and a core network device may execute a security policy negotiation procedure in an interface setup process. There are three manners of triggering security policy negotiation in the interface setup process.

Manner 1: The access network device sends an interface setup request message carrying a negotiation request message to the core network.

Manner 2: After the core network sends an interface setup response message to the access network device, the access network device sends a negotiation request message to the core network.

Manner 3: The access network device sends an interface setup request message to the core network, and the core network sends an interface setup response message carrying a negotiation request message to the access network device.

For example, the foregoing interface may be an NG interface.

After the negotiation procedure is triggered, for the specific negotiation procedure, refer to the method shown in FIG. 5A and FIG. 5B or FIG. 6A and FIG. 6B, to obtain a security policy and execute a specific trustworthiness service according to the negotiated security policy.

The foregoing three policy negotiation triggering scenarios are merely examples for description, and are not all triggering scenarios. This is not limited in embodiments of this application.

As shown in FIG. 7(f), two function network elements may execute a security policy negotiation procedure in a service request process. There are three manners of triggering security policy negotiation in the service request process.

Manner 1: An NF #1 (serving as a service consumer) sends a service request message carrying a negotiation request message to an NF #2 (serving as a service producer).

Manner 2: An NF #1 (serving as a service consumer) sends a negotiation request message to an NF #2 (serving as a service producer) to obtain a trustworthiness policy, and the NF #1 sends a service request message to the NF #2.

Manner 3: An NF #1 (serving as a service consumer) sends a service request message to an NF #2 (serving as a service producer), and the NF #2 sends a negotiation request message to the NF #1.

After the negotiation procedure is triggered, for the specific negotiation procedure, refer to the method shown in FIG. 5A and FIG. 5B or FIG. 6A and FIG. 6B, to obtain a security policy and execute a specific trustworthiness service according to the negotiated security policy.

The foregoing three policy negotiation triggering scenarios are merely examples for description, and are not all triggering scenarios. This is not limited in embodiments of this application.

In this application, communication nodes may perform security negotiation by using the security negotiation procedure provided in the embodiments, to obtain the security policy. The foregoing triggering scenarios are merely examples for description. There is no limitation on implementation of embodiments of this application.

In this application, when two communication nodes change, a new security negotiation procedure may also be triggered.

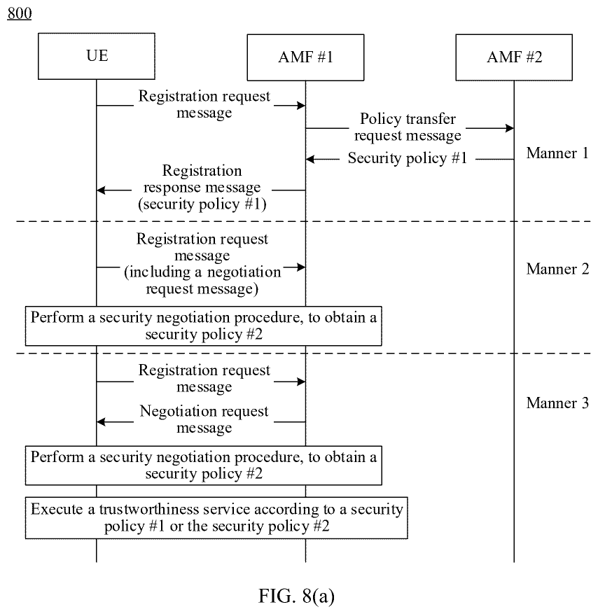

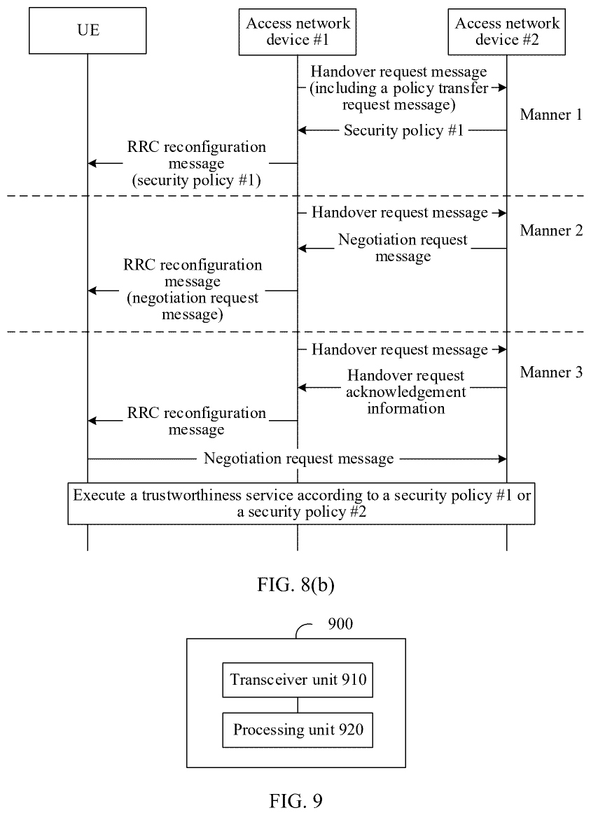

FIG. 8(a) and FIG. 8(b) each shows a security negotiation procedure triggered when a communication node changes.

As shown in FIG. 8(a), an old AMF (AMF #2) and a new AMF (AMF #1) in a roaming scenario in an existing standard are from a same operator. In a future network, a UE may have a capability of crossing operators, and may access different operator networks. In this case, the AMF #2 and the AMF #1 are from core networks of different operators. In these two roaming scenarios, an old security policy #1 may be reused, or a security policy #2 may be obtained through renegotiation.

FIG. 8(a) shows three manners of determining a security policy after a UE is handed over between different operators.

Manner 1: The UE sends a registration request message to the AMF #1, and the AMF #1 sends a policy transfer request message to the AMF #2, that is, sends a request to the AMF #2 for the original security policy #1. The AMF #2 sends the security policy #1 to the AMF #1,and the AMF #1 sends a registration response message carrying the security policy #1 to the UE.

Manner 2: The UE sends a registration request message carrying a negotiation request message to the AMF #1, and the UE sends the registration request message carrying the negotiation request message to the AMF #1, to perform a security negotiation procedure, to obtain the security policy #2.

Manner 3: The UE sends a registration request message to the AMF #1, and the AMF #1 sends a negotiation request message to the UE, to perform a security negotiation procedure, to obtain the security policy #2.

After the negotiation procedure is triggered, for the specific negotiation procedure, refer to the method shown in FIG. 5A and FIG. 5B or FIG. 6A and FIG. 6B, to obtain the security policy #2 and execute a specific trustworthiness service according to the negotiated security policy #2 or the original security policy #1.

The foregoing three scenarios are merely examples for description, and are not all application scenarios. This is not limited in embodiments of this application.

As shown in FIG. 8(b), after a UE is handed over between access network devices, the UE may reuse an old security policy #1, or may obtain a security policy #2 through renegotiation.

FIG. 8(b) shows three manners of determining a security policy after the UE is handed over between different access network devices.

Manner 1: An access network device #1 (a source access network device) sends a handover request message carrying a policy transfer request message to an access network device #2 (a target access network device). The access network device #2 sends the security policy #1 to the access network device #1. The access network device #1 sends RRC reconfiguration information carrying the security policy #1 to the UE.

Manner 2: An access network device #1 (a source access network device) sends a handover request message to an access network device #2 (a target access network device). The access network device #2 sends a handover request acknowledgment message carrying a negotiation request message to the access network device #1. The access network device #1 sends RRC reconfiguration information carrying the negotiation request message to the UE, to execute a security policy negotiation procedure, to obtain the security policy #2.

Manner 3: An access network device #1 (a source access network device) sends a handover request message to an access network device #2 (a target access network device), the access network device #2 sends a handover request acknowledgment message to the access network device #1, the access network device #1 sends RRC reconfiguration information to the UE, and the UE sends a negotiation request message to the access network device #2, or may include the negotiation request message in an RRC reconfiguration message, to execute a security policy negotiation procedure, to obtain the security policy #2.

The foregoing three scenarios are merely examples for description, and are not all application scenarios. This is not limited in embodiments of this application.

It should be noted that, in this application, generation of the security policy is based on at least one of the following input parameters: a trustworthiness requirement statement of a node, a network global trustworthiness security policy, and a trustworthiness configuration of a management end. When any one of the three input parameters changes, the node may be triggered to execute a new security policy negotiation procedure.

In a possible implementation, the node #1 and the node #2 in FIG. 5A and FIG. 5B are used as an example, and a trustworthiness requirement of the node #1 may change. For example, a user inputs a new trustworthiness requirement through a human-machine interface. For another example, an application scenario changes, and the node #1 generates a new trustworthiness requirement according to a preset rule. For another example, an application scenario changes, and the node #1 generates a new initial trustworthiness requirement based on AI. For another example, a security capability configuration of the TGF #1 changes, and a new trustworthiness requirement parameter is generated. After the trustworthiness requirement of the node #1 is updated, the TGF #1 updates the first information based on the new trustworthiness requirement. In a subsequent procedure, updated first information is used to generate a new security policy.

In a possible implementation, the node #1 and the node #2 in FIG. 5A and FIG. 5B are used as an example, and a network global trustworthiness policy of the node #1 may change. For example, a situational awareness result of the TEF #1 of the node #1 changes, and a new network global trustworthiness policy is generated. For another example, a configuration of the TEF #1 changes, an application scenario changes, and a new network global trustworthiness policy is generated. After the network global trustworthiness policy of the node #1 is updated, the TGF #1 updates the first information according to the new network global trustworthiness policy. In a subsequent procedure, updated first information is used to generate a new security policy.

In a possible implementation, the node #1 and the node #2 in FIG. 5A and FIG. 5B are used as an example, and a trustworthiness configuration of the node #1 changes. For example, an operator administrator changes a security setting. For another example, an OAM generates a new trustworthiness configuration field of a management end. After the trustworthiness configuration of the node #1 is updated, the TGF #1 updates the first information based on the new trustworthiness configuration. In a subsequent procedure, updated first information is used to generate a new security policy.

The foregoing scenarios are merely examples for description, and are not all application scenarios. This is not limited in embodiments of this application.

FIG. 9 is a block diagram of a communication apparatus according to an embodiment of this application. The communication apparatus 900 shown in FIG. 9 includes a transceiver unit 910 and a processing unit 920. The transceiver unit 910 may communicate with the outside, and the processing unit 920 is configured to process data. The transceiver unit 910 may also be referred to as a communication interface or a communication unit.

Optionally, the transceiver unit 910 may include a sending unit and a receiving unit. The sending unit is configured to perform a sending operation in the foregoing method embodiments. The receiving unit is configured to perform a receiving operation in the foregoing method embodiments.

It should be noted that the communication apparatus 900 may include a sending unit, but does not include a receiving unit. Alternatively, the communication apparatus 900 may include a receiving unit, but does not include a sending unit. This may be specifically determined depending on whether the foregoing solution performed by the communication apparatus 900 includes a sending action and a receiving action.

Optionally, the communication apparatus 900 may further include a storage unit. The storage unit may be configured to store instructions and/or data. The processing unit 920 may read the instructions and/or the data in the storage unit.

In a design, the communication apparatus 900 may be configured to perform an action performed by the first security module in the foregoing method embodiments.

Optionally, the communication apparatus 900 may perform an action performed by the first security module in the foregoing method embodiments. The first security module may be a security function unit, module, or device, or may be a chip or a circuit in a security function unit, module, or device, or may be a logical module or software that can implement all or some functions of a security function unit, module, or device. This is not limited in this application.

Optionally, the communication apparatus 900 may be the first security module. The transceiver unit 910 is configured to perform a receiving or sending operation of the first security module in the foregoing method embodiments, and the processing unit 920 is configured to perform a processing operation of the first security module in the foregoing method embodiments.

Optionally, the communication apparatus 900 may be a device including the first security module. Alternatively, the communication apparatus 900 may be a component configured in the first security module, for example, a chip in the first security module. In this case, the transceiver unit 910 may be a transceiver circuit, a pin, or the like. Specifically, the transceiver circuit may include an input circuit and an output circuit, and the processing unit 920 may include a processing circuit.

In a possible implementation, the processing unit 920 is configured to generate a security policy based on first information and second information, where the first information includes a trustworthiness requirement statement of a first node and/or a network global trustworthiness policy of the first node, the second information includes a trustworthiness requirement statement of a second node and/or a network global trustworthiness policy of the second node, a first security module is a security module serving the first node, and a second security module is a security module serving the second node. The transceiver unit 910 configured to send the security policy to the second security module, where the security policy is used for secure communication between the first node and the second node.

In a possible implementation, the transceiver unit 910 is further configured to receive the second information from the second security module.

In a possible implementation, the transceiver unit 910 is specifically configured to receive a first request message from the second security module, where the first request message is used to request the first security module to perform security negotiation, and the first request message includes the second information.

In a possible implementation, the transceiver unit 910 is specifically configured to send a second request message to the second security module, where the second request message is used to request the second security module to perform security negotiation.

In a possible implementation, the first information further includes a trustworthiness configuration obtained from a management end, and the second information further includes a trustworthiness configuration obtained from the management end.

Optionally, the communication apparatus 900 may perform an action performed by a requester in the foregoing method embodiments. The requester may be a terminal device, a network device, or a security module (the second security module), or may be a chip or a circuit in a terminal device, a network device, or a security module, or may be a logical module or software that can implement all or some functions of a terminal device, a network device, or a security module. This is not limited in this application.

Optionally, the communication apparatus 900 may be the requester, the transceiver unit 910 is configured to perform a receiving or sending operation of the requester in the foregoing method embodiments, and the processing unit 920 is configured to perform an internal processing operation of the requester in the foregoing method embodiments.

Optionally, the communication apparatus 900 may be a device including the requester. Alternatively, the communication apparatus 900 may be a component configured in the requester, for example, a chip in the requester. In this case, the transceiver unit 910 may be a transceiver circuit, a pin, or the like. Specifically, the transceiver circuit may include an input circuit and an output circuit, and the processing unit 920 may include a processing circuit.

In a possible implementation, the transceiver unit 910 is configured to determine second information, where the second information is used by a first security module to generate a security policy based on first information, the first information includes a trustworthiness requirement statement of a first node and/or a network global trustworthiness policy of the first node, the second information includes a trustworthiness requirement statement of a second node and/or a network global trustworthiness policy of the second node, the first security module is a security module serving the first node, and a second security module is a security module serving the second node. The transceiver unit 910 is further configured to receive the security policy from the first security module, where the security policy is used for secure communication between the first node and the second node.

In a possible implementation, the transceiver unit 910 is further configured to send the second information to the first security module.

In a possible implementation, the transceiver unit 910 is specifically configured to send a first request message to the first security module, where the first request message is used to request the first security module to perform security negotiation, and the first request message includes the second information.

In a possible implementation, the transceiver unit 910 is specifically configured to receive a second request message from the first security module, where the second request message is used to request the second security module to perform security negotiation.

In a possible implementation, the first information further includes a trustworthiness configuration obtained from a management end, and the second information further includes a trustworthiness configuration obtained from the management end.

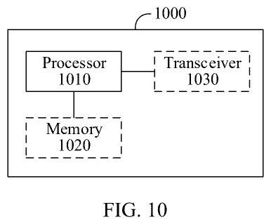

As shown in FIG. 10, an embodiment of this application further provides a communication apparatus 1000. The communication apparatus 1000 includes a processor 1010. The processor 1010 is coupled to a memory 1020. The memory 1020 is configured to store a computer program or instructions and/or data. The processor 1010 is configured to execute the computer program or the instructions and/or the data stored in the memory 1020, so that the method in the foregoing method embodiments is performed.

Optionally, the communication apparatus 1000 includes one or more processors 1010.

Optionally, as shown in FIG. 10, the communication apparatus 1000 may further include the memory 1020.

Optionally, the communication apparatus 1000 may include one or more memories 1020.

Optionally, the memory 1020 and the processor 1010 may be integrated together or separately disposed.

Optionally, as shown in FIG. 10, the communication apparatus 1000 may further include a transceiver 1030 and/or a communication interface. The transceiver 1030 and/or the communication interface are/is configured to receive and/or send a signal. For example, the processor 1010 is configured to control the transceiver 1030 and/or the communication interface to receive and/or send a signal.

Optionally, a component that is in the transceiver 1030 and that is configured to implement a receiving function may be considered as a receiving module, and a component that is in the transceiver 1030 and that is configured to implement a sending function may be considered as a sending module. That is, the transceiver 1030 includes a receiver and a transmitter. The transceiver may also be sometimes referred to as a transceiver machine, a transceiver module, a transceiver circuit, or the like. The receiver may also be sometimes referred to as a receiver machine, a receiving module, a receiver circuit, or the like. The transmitter may also be sometimes referred to as a transmitter machine, a transmitter, a transmitting module, a transmitting circuit, or the like.

In a solution, the communication apparatus 1000 is configured to implement an operation performed by the first security module in the foregoing method embodiments. For example, the processor 1010 is configured to implement an operation (for example, an operation in S420) performed by the first security module in the foregoing method embodiments, and the transceiver 1030 is configured to implement a receiving or sending operation (for example, an operation in S430) performed by the first security module in the foregoing method embodiments.

In another solution, the communication apparatus 1000 is configured to implement an operation performed by the second security module in the foregoing method embodiments. For example, the transceiver 1030 is configured to implement a receiving or sending operation (for example, an operation in S430) performed by the second security module in the foregoing method embodiments.

It should be noted that the foregoing method embodiments of this application may be applied to a processor, or implemented by a processor. The processor may be an integrated circuit chip and has a signal processing capability. In an implementation process, steps in the foregoing method embodiments can be implemented by using a hardware integrated logical circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, the steps, and logical block diagrams that are disclosed in embodiments of this application. The general-purpose processor may be a microprocessor, or the processor may be any conventional processor or the like. The steps of the methods disclosed with reference to embodiments of this application may be directly performed and completed by a hardware decoding processor, or may be performed and completed by using a combination of hardware in the decoding processor and a software module. The software module may be located in a mature storage medium in the art, for example, a random access memory, a flash memory, a read-only memory, a programmable read-only memory, an electrically erasable programmable memory, or a register. The storage medium is located in the memory, and the processor reads information in the memory and completes the steps in the foregoing methods in combination with the hardware of the processor.

It may be understood that the memory in embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example, and not limitation, many forms of RAMs may be used, for example, a static random access memory (Static RAM, SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (Synchlink DRAM, SLDRAM), and a direct rambus random access memory (DR RAM). It should be noted that the memory of the systems and methods described in this specification includes but is not limited to these and any memory of another proper type.

It should be understood that the term “and/or” in this specification describes only an association relationship between associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or another form.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, function units in embodiments of this application may be integrated into one processing unit, each of the units may exist alone physically, or two or more units are integrated into one unit.

When the functions are implemented in a form of a software function unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The storage medium includes any medium that can store program code, for example, a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, applicable for a first security module, comprising:
generating a security policy based on first information and second information, wherein the first information comprises a trustworthiness requirement statement of a first node and/or a network global trustworthiness policy of the first node, the second information comprises a trustworthiness requirement statement of a second node and/or a network global trustworthiness policy of the second node, the first security module is a security module serving the first node, and the second security module is a security module serving the second node; and
sending the security policy to the second security module, wherein the security policy is used for secure communication between the first node and the second node.

2. The method according to claim 1, wherein the method further comprises:
receiving the second information from the second security module.

3. The method according to claim 2, wherein the receiving, by the first security module, the second information from the second security module comprises:
receiving a first request message from the second security module, wherein the first request message is used to request the first security module to perform security negotiation, and the first request message comprises the second information.

4. The method according to claim 1, wherein the method further comprises:
sending a second request message to the second security module, wherein the second request message is used to request the second security module to perform security negotiation.

5. The method according to claim 1, wherein the first information further comprises a trustworthiness configuration obtained from a management end, and the second information further comprises a trustworthiness configuration obtained from the management end.

6. A communication method, applicable for a second security module comprising:
determining second information, wherein the second information is used by a first security module to generate a security policy based on first information, the first information comprises a trustworthiness requirement statement of a first node and/or a network global trustworthiness policy of the first node, the second information comprises a trustworthiness requirement statement of a second node and/or a network global trustworthiness policy of the second node, the first security module is a security module serving the first node, and the second security module is a security module serving the second node; and
receiving the security policy from the first security module, wherein the security policy is used for secure communication between the first node and the second node.

7. The method according to claim 6, wherein the method further comprises:
sending the second information to the first security module.

8. The method according to claim 7, wherein the sending the second information to the first security module comprises:
sending a first request message to the first security module, wherein the first request message is used to request the first security module to perform security negotiation, and the first request message comprises the second information.

9. The method according to claim 6, wherein the method further comprises:
receiving a second request message from the first security module, wherein the second request message is used to request the second security module to perform security negotiation.

10. The method according to claim 6, wherein the first information further comprises a trustworthiness configuration obtained from a management end, and the second information further comprises a trustworthiness configuration obtained from the management end.

11. The method according to claim 7, wherein the second security module stores the security policy.

12. A communication apparatus, comprising: at least one processor coupled to at least one memory storing a computer program including instructions that, when executed by the processor, cause the communication apparatus to perform:
generating a security policy based on first information and second information, wherein the first information comprises a trustworthiness requirement statement of a first node and/or a network global trustworthiness policy of the first node, the second information comprises a trustworthiness requirement statement of a second node and/or a network global trustworthiness policy of the second node, the first security module is a security module serving the first node, and the second security module is a security module serving the second node; and
sending the security policy to the second security module, wherein the security policy is used for secure communication between the first node and the second node.

13. The communication apparatus according to claim 12, wherein when the instructions are executed by the processor, further cause the communication apparatus to perform:
receiving the second information from the second security module.

14. The communication apparatus according to claim 13, wherein the receiving the second information from the second security module comprises:
receiving a first request message from the second security module, wherein the first request message is used to request the first security module to perform security negotiation, and the first request message comprises the second information.

15. The communication apparatus according to claim 12, wherein when the instructions are executed by the processor, further cause the communication apparatus to perform:
sending a second request message to the second security module, wherein the second request message is used to request the second security module to perform security negotiation.

16. The communication apparatus according to claim 12, wherein the first information further comprises a trustworthiness configuration obtained from a management end, and the second information further comprises a trustworthiness configuration obtained from the management end.
